(19) United States
(12) Patent Application Publication
(10) Pub. No.: US 2009/0132534 A1
(43) Pub. Date: May 21, 2009

(54) Remote replication synchronizing/accessing system and method thereof

(75) Inventors: Hai-Ting Yao, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/984,747

(22) Filed: Nov. 21, 2007

(51) Int. Cl. G06F 17/30

(52) U.S. Cl. 707/8; 707/E17.007

(57) ABSTRACT

A remote replication synchronizing/accessing system and a method thereof applied between a local system and a remote mirroring system of the local system. After the remote mirroring system is created, an initialization synchronous operation of the remote mirroring system is sequentially performed according to a sequence of data blocks in storage of the local system. A small-granulated exclusive lock function is established between the initialization synchronous operation and a data-accessing request operation of the local system. During the initialization synchronous process of the remote mirroring system, it is determined whether a data block position corresponding to the current initialization synchronous operation is the same as that corresponding to the data-accessing request operation or not. Finally, according to a position determination result and the small-granulated exclusive lock function, a data-accessing request is directed processed or processed after finishing the initialization synchronous operation.

### BACKGROUND OF THE INVENTION

1. Field of the Invention

The present invention relates to a remote replication synchronizing/accessing system and a method thereof, and more particularly to a method of synchronizing remote data mirroring, capable of realizing the concurrent operation between an initialization synchronization operation and a data access operation of an application, without being interrupted.

2. Related Art

Currently, a computer storage system has been widely used to store some important data in people's daily life and work, and its high-efficient and safe data backup are concerned and paid more attention by computer users. Once an operating system or storage is failed or is damaged, the damaged data may be substituted rapidly by the stored backup data, so as to ensure the completeness of the key data and the continuity of normal business.

Data replication may be regarded as a backup policy, which is classified into local replication and remote replication. The local replication has a rapid speed in backing up data, since no network transmission is used, but in such a replication mode, the original data and backup data are both stored in the same system, and thus, it can solve the problem that the original data is damaged merely under the condition that the system is available. The remote replication offers stronger guarantee for the business continuity and disaster backup, and establishes data mirroring at a remote site, and thus, the data can be restored soon even if the local system is damaged.

After the remote mirroring is created, some unknown data is stored in the space of the storage disk where the remote mirroring is established, which may be fragments of former documents or status of the disk when leaving factory. If the data blocks in the remote mirroring are read at this time, unexpected data contents may be read. Therefore, regardless of the local replication or the remote replication, the initialization synchronization should be performed to the data mirroring firstly. Synchronization means to read all data in the local system to be backed up and to replicate the data into the remote mirroring, so that the data mirroring can acquire the data backup completely the same as that in the local system. Thus, by means of receiving and processing a new input/output (I/O) request for data access sent by the application of the local system on this basis, the data mirroring function can be achieved. However, if the remote replication receives and processes the new I/O request sent by the local system without performing the initialization synchronization, only the data block requested this time is consistent with the data of the local system, but other data blocks are random and unknown. For example, the application begins to write two data blocks in the local system from the 100^{th} data block, i.e., the 100^{th} data block and the 101^{th} data block, and the two data blocks are replicated into the remote mirroring through a remote replication system, and as a result, there are only the 100^{th} data block and the 101^{th} data block in the remote mirroring being consistent with the local system, but the data in the other data blocks are unexpected. Therefore, in the conventional art, the data service of the local system must be interrupted, and then, new service cannot begin once again until the synchronization is finished. As a result, the speed for the local terminal to request accessing the remote mirroring is influenced to a certain extent, and the accessing speed is reduced.

### SUMMARY OF THE INVENTION

In order to solve the problems and defects in the conventional art, the present invention is directed to a remote replication synchronizing/accessing system and a method thereof, capable of realizing a concurrent operation between an initialization synchronization operation and a data-accessing operation of an application, ensuring non-interrupted remote data mirroring synchronization, and increasing the data accessing accuracy.

The remote replication synchronizing/accessing system provided by the present invention is applied between a local system and a remote mirroring system of the local system. The system includes a synchronization module, an exclusive module, a determination module, and a request processing module. The synchronization module performs an initialization synchronous operation of the remote mirroring system sequentially according to a sequence of data blocks in storage of the local system after the remote mirroring system is created. The exclusive module establishes a small-granulated exclusive lock function between the initialization synchronous operation and a data-accessing request operation of the local system, so as to prevent the initialization synchronous operation and the data-accessing request operation from being conducted on the same data block in the storage at a same time. The determination module determines whether a data block position corresponding to the current initialization synchronous operation is the same as that corresponding to the data-accessing request operation or not during the initialization synchronous process of the remote mirroring system. The request processing module directly processes the data-accessing request or processes the data-accessing request after finishing the initialization synchronous operation according to a determination result about the data block position from the determination module and the small-granulated exclusive lock function.

The remote replication synchronizing/accessing method provided by the present invention is applied between a local system and a remote mirroring system of the local system. The method includes the following steps: firstly, performing an initialization synchronous operation of the remote mirroring system sequentially according to a sequence of data blocks in a storage of the local system after the remote mirroring system is created; establishing a small-granulated exclusive lock function between the initialization synchronous operation and a data-accessing request operation of the local system, so as to prevent the initialization synchronous operation and the data-accessing request operation from being conducted on the same data block in the storage at the same time; determining whether a data block position corresponding to the current initialization synchronous operation is the same as that corresponding to the data-accessing request operation or not during the initialization synchronous process of the remote mirroring system; and when the data block position corresponding to the data-accessing request operation is the same as that corresponding to the current initialization synchronous operation, processing the data-accessing request after finishing the initialization synchronization of the data block according to the small-granulated exclusive lock function.

In addition, when the data block position corresponding to the data-accessing request operation is before that corresponding to the current initialization synchronous operation, the data-accessing request is directly performed, and the remote replication is performed for the remote mirroring system according to the data-accessing request. When the data block position corresponding to the data-accessing request operation is after that corresponding to the current initialization synchronous operation, the initialization synchronization on the data block corresponding to the data-accessing request operation is sequentially performed after the data-accessing request is processed according to the small-granulated exclusive lock function.

Since the initialization synchronization is performed right after the remote mirroring is created and a small-granulated exclusive lock function is established between the synchronization operation and the data-accessing request of the application, the remote replication synchronizing/accessing system and method provided by the present invention are capable of realizing the concurrent operation between two kinds of operations without influencing each other when a synchronization thread and a data-accessing thread are directed to the same data block but at different time. Furthermore, when the synchronization thread and the data-accessing thread are directed to the same data block at the same time at a certain point, the remote replication synchronizing/accessing system and method provided by the present invention are capable of ensuring the accuracy of the data and minimizing the accessing speed through the small-granulated exclusive function.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a block diagram of a remote replication synchronizing/accessing system according to the present invention;

FIG. 2 is a flow chart of a remote replication synchronizing/accessing method according to the present invention;

FIG. 3 is a flow chart of a thread of processing a data-accessing request; and

FIG. 4 is a flow chart of a thread of processing a synchronous operation.

### DETAILED DESCRIPTION OF THE INVENTION

The features and practice of the preferred embodiments of the present invention will be illustrated below in detail with reference to the accompanying drawings.

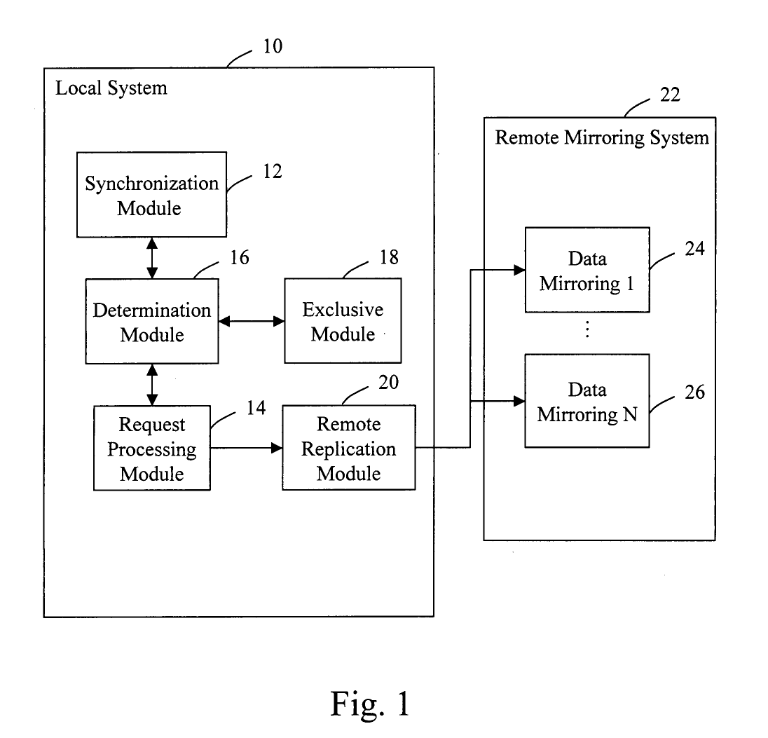

Referring to FIG. 1, it shows a remote replication synchronizing/accessing system provided by the present invention.

As shown in FIG. 1, the system is applied between a local system 10 and a remote mirroring system 22. The remote mirroring system 22 has a plurality of data mirroring 24 and 26 being created subordinately, so as to store remote backup of data in storage of the local system 10.

The remote replication synchronizing/accessing system provided by the present invention is used for performing an initialization synchronization of the remote mirroring system and processing a data-accessing operation of an application in the local system 10 at the same time. The main principle of the system will be explained in detail with reference to FIG. 1.

As shown in FIG. 1, the synchronizing/accessing system includes a synchronization module 12, a request processing module 14, a determination module 16, an exclusive module 18, and a remote replication module 20. The synchronization module 14 is used to perform the initialization synchronization of the remote mirroring system 10 right after the remote mirroring system 22 is created, i.e., to read all data according to a sequence of data blocks in the storage of the local system 10 and replicate the data in the remote mirroring system 22. Furthermore, when there is a data-accessing request for the application, the remote mirroring of the data on the data block which has already undergone the initialization synchronization may be realized.

The request processing module 14 is used to process the data-accessing request sent from the application to the local system 10, and then sends this request to the remote mirroring system 20, so as to replicate the data in the remote data mirroring 24 or 26. If the data block requested by the application has already finished the initialization synchronization for the remote mirroring, the request processing module 14 directly sends the request to the remote mirroring system 22 after the requested process has been finished.

However, when the synchronization module 12 performs the initialization synchronous operation, if the data-accessing request sent from the application to the local system 10 is directed to a data block in the storage that has not been synchronized yet, the request processing module 14 cannot realize the remote data mirroring function. Therefore, the present invention also includes the determination module 16 and the exclusive module 18, so as to make coordination and cooperation between the synchronization module 12 and the request processing module 14 when the data block corresponding to the data-accessing request operation of the application has not been synchronized yet or the synchronization module 12 is performing the initialization synchronization on the data block.

When the synchronization module 12 performs the initialization synchronous operation of the remote mirroring system 20, if the local system 10 receives a data-accessing request from the application, the determination module 16 determines whether a data block position corresponding to the current initialization synchronous operation is the same as that corresponding to the data-accessing request operation or not.

The exclusive module 18 is used to establish a small-granulated exclusive lock function between the synchronous operation of the synchronization module 12 and the request operation of the request processing module 14, so as to prevent the initialization synchronous operation and the data-accessing request operation from being conducted on the same data block in the storage at the same time. The small-granulated exclusive lock function is a mechanism that renders exclusive and waiting effects only when an initialization synchronization thread and a data-accessing request thread read the same data block, and it enables both of them to operate concurrently if they do not read the same data block, thereby not only enhancing the speed for initialization synchronization, but also enhancing the speed for assessing data from the local system. The granularity of the exclusive lock merely indicates one data block when the two threads process the same position, and the unit of the data block is generally tiny, so it may be finished quickly, in this way, no matter which tread possesses the lock, the lock will be released quite soon. The probability that two threads read the same data block is not high, so the system is totally concurrent in most of the time. As for this function, the probability that the two threads need to be exclusive is low, and even if the two threads are exclusive, the time is very short (because the granularity merely indicates one data block and the lock will be released soon). Therefore, the concurrency is provided. The process for realizing the small-granulated lock function will be described below in detail.

Therefore, the synchronization module 12 and the request processing module 14 may concurrently operate without interfering with each other under a certain condition. When the synchronization module 12 or the request processing module 14 performs the synchronization or request operation on a data block, the exclusive module 18 applies a lock on the operations, so that the two kinds of operations are exclusive in terms of a specific priority level. Therefore, according to the position determination result transmitted from the determination module 16, the exclusive module 18 performs a corresponding exclusive lock function.

When the synchronization module 12 and the request processing module 14 in the present invention conduct operations on the same data block at different time, they may concurrently operate without influencing each other. However, when the determination module 16 determines that the data block position (“the request position” hereinafter) corresponding to the data-accessing request operation is the same as the data block position (“the synchronization position” hereinafter) corresponding to the current initialization synchronous operation, the exclusive module 18 starts the small-granulated exclusive lock function, so that the request processing module 14 processes the data-accessing request after the synchronization module 12 finishes the initialization synchronization on the data block.

When the determination module 16 determines that the request position is before the synchronization position, i.e., the synchronization module 12 has already performed the synchronous operation on the data block corresponding to the data-accessing request operation of the application, the request processing module 14 directly processes the data-accessing request and sends a request to the remote replication module 20, so as to directly perform the remote replication for the suitable data mirroring 24 or 26 of the remote mirroring system 20 in response to the request.

If the determination module 16 determines that the request position is after the synchronization position, i.e., the initialization synchronization has not yet been performed on the data block corresponding to the data-accessing request operation, the request processing module 14 merely finishes the data request for the local system, and will not send any request to the remote mirroring system 20 for the time being, and till the synchronization module 12 has performed the synchronization on this data block, the remote replication module 20 performs the remote replication. When the request processing module 14 performs the data request for the local system, the request may be added to a list. If the synchronization module 12 has finished the current data block and needs to sequentially perform the next data block, all requests in the list are read, and then the determination module 16 determines whether the synchronization position to be performed by the synchronization module 12 is the same as the current request position of the request processing module 14 or not. If the two positions are the same, the synchronization module 12 needs to perform the synchronization after the request has been finished according to the small-granulated exclusive lock function; and if the positions are not the same, the synchronization module 12 and the request processing module 14 may operate concurrently. Under the aforementioned circumstance, the request processing module 14 deletes the corresponding request from the list after finishing this request.

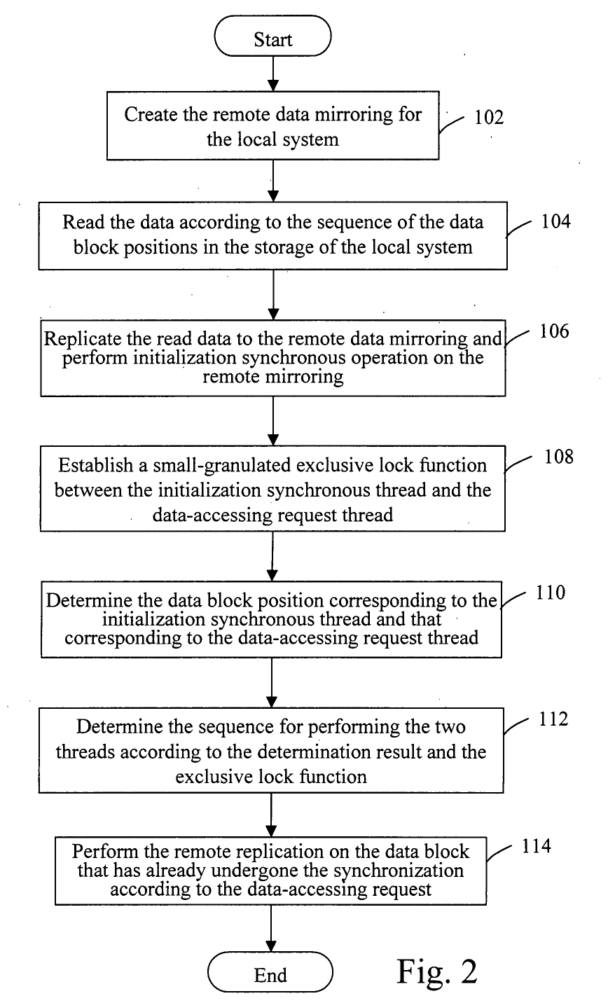

Referring to FIG. 2, it is a flow chart of a remote replication synchronizing/accessing method according to the present invention. As shown in FIG. 2, the remote replication synchronizing/accessing method according to the present invention includes the following steps: firstly, creating a remote data mirroring for the local system (Step 102); next, reading the data according to the sequence of the data block positions in the storage of the local system (Step 104); then, replicating the read data into the remote data mirroring, so as to perform the initialization synchronous operation on the remote mirroring (Step 106); then, establishing a small-granulated exclusive lock function between an initialization synchronization thread and a data-accessing request thread (Step 108), so as to prevent the initialization synchronous operation and the data-accessing request operation from being conducted on the same data block in the storage at the same time; then, determining the data blocks positions corresponding to the initialization synchronization and data-accessing request operations, when performing the synchronous operation or processing the data-accessing request (Step 110); and finally, determining the sequence for performing the two threads according to the determination result and the exclusive lock function (Step 112), and meanwhile performing the remote replication on the data block that has already undergone the synchronization according to the data-accessing request (Step 114).

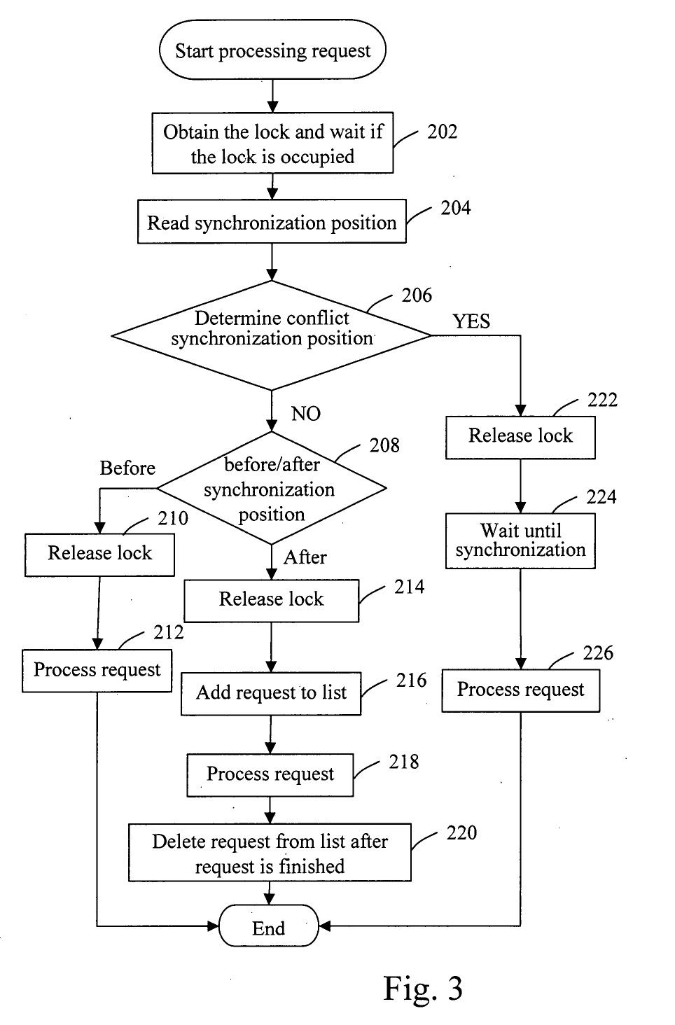

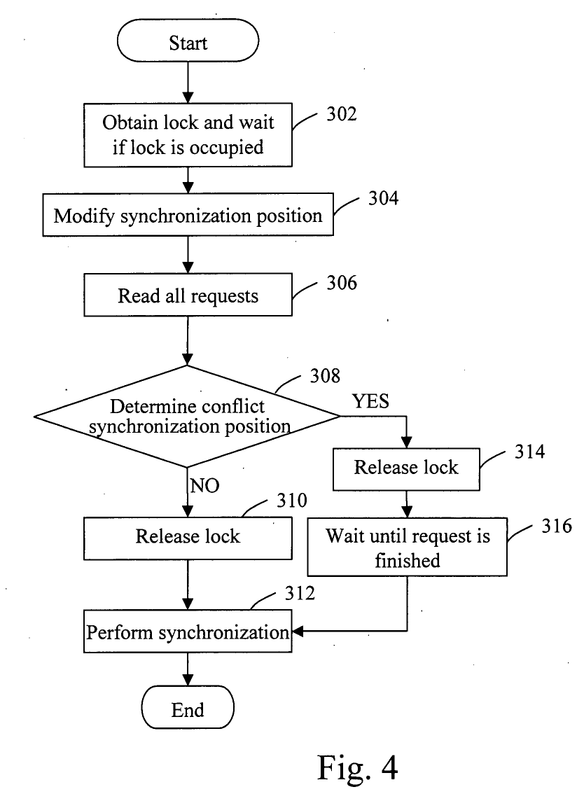

The aforementioned steps show a general flow chart of the remote replication synchronizing/accessing method in the present invention. The detailed steps for the thread of processing the data-accessing request and the thread of processing the synchronous operation in the present invention will be described below with reference to FIGS. 3 and 4. FIG. 3 is a flow chart of the thread of processing the data-accessing request and FIG. 4 is a flow chart of the thread of processing the synchronous operation.

As shown in FIG. 3, when the thread of processing the data-accessing request (“the request thread” hereinafter) begins processing the data-accessing request from the application, firstly, an operation of obtaining a lock is performed according to the small-granulated exclusive lock function established between two threads, and once the lock is occupied, it waits till the privilege for obtaining a lock is assigned (Step 202). After the lock is obtained, the request thread firstly reads the data block position corresponding to the initialization synchronous operation (“the synchronization position” hereinafter) being performed by the thread of processing synchronous operation (“the synchronization thread” hereinafter) (Step 204). Then, it is determined whether the data block position corresponding to the data-accessing request operation (“the request position” hereinafter) processed by the request thread is in conflict with the synchronization position or not, i.e., whether the two positions are the same or not (Step 206). If the two positions are the same, according to the small-granulated exclusive lock function, the request thread releases the lock (Step 222), and waits until the synchronization thread finishes the initialization synchronization on the data block corresponding to the position (Step 224), and then processes the data-accessing request (Step 226).

If the request position is different from the synchronization position, it proceeds to Step 208 to continue determining the request position is before or after the synchronization position (Step 208). When it is determined that the request position is before the synchronization position, i.e., the synchronization thread has already performed the synchronous operation on the data block corresponding to the data-accessing request operation of the application, the request thread releases the lock (Step 210) and directly processes the data-accessing request (Step 212), so as to send the request to the remote mirroring to perform the remote replication.

If the request position is after the synchronization position, i.e., the initialization synchronization has not yet been performed on the data block corresponding to the data-accessing request operation, the lock is released (Step 214) and the request is added to the list (Step 216). Then, only the data request for the local system is finished (Step 218), the request is not sent to the remote mirroring for the time being, and the remote replication cannot be performed until the synchronization thread performs the synchronization on the data block. After the request has been finished, the request is deleted from the list (Step 220).

The request is added to the list in consideration of the exclusive problem caused by the situation that the synchronization thread intends to perform the synchronous operation on the current data block while the request thread is processing the request on the same data block. Therefore, the lock is released and becomes exclusive after the synchronization position is determined and before the data is accessed, so as to ensure that the synchronization thread will not enter the data block to perform synchronization on the data at the same time. The detailed steps may be obtained referring to FIG. 4.

As shown in FIG. 4, when the synchronization thread begins the operation, firstly, an operation of obtaining a lock is performed, but once the lock is occupied, the synchronization thread should wait (Step 302). When the synchronization thread has finished the current data block and intends to process the next one sequentially, the synchronization position should be modified (Step 304). Next, all requests added to the list are read by the request thread (Step 306), and the modified synchronization position is further determined according to the request position represented by the requests in the list, i.e., it is determined whether the synchronization position to be performed with the synchronous operation is in conflict with the request position being processed by the request thread (Step 308). If the positions conflict with each other, the current data block is processed by the request thread. Therefore, the synchronization thread releases the lock according to the small-granulated exclusive lock function (Step 314) and wait until the request has been finished (Step 316). Once the request is finished, the synchronization is performed on the data at the current position (Step 312).

If the positions do not conflict with each other, the synchronization thread and the request thread may perform individual operations concurrently. Therefore, the synchronization thread releases the lock (Step 310) and performs the synchronization on the data lock at the current position (Step 312).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A remote replication synchronizing/accessing system, applied between a local system and a remote mirroring system of the local system, the system comprising:
a synchronization module, for performing an initialization synchronous operation of the remote mirroring system sequentially according to a sequence of data blocks in a storage of the local system after the remote mirroring system is created;
an exclusive module, for establishing a small-granulated exclusive lock function between the initialization synchronous operation and a data-accessing request operation of the local system, so as to prevent the initialization synchronous operation and the data-accessing request operation from being conducted on the same data block in the storage at the same time;
a determination module, for determining whether a data block position corresponding to the current initialization synchronous operation is the same as that corresponding to the data-accessing request operation or not during the initialization synchronous process of the remote mirroring system; and
a request processing module, for directly processing the data-accessing request or processing the data-accessing request after the initialization synchronous operation according to a determination result about the data block position from the determination module and the small-granulated exclusive lock function.

2. The remote replication synchronizing/accessing system as claimed in claim 1, wherein if the data block position corresponding to the data-accessing request operation is the same as that corresponding to the current initialization synchronous operation, the request processing module processes the data-accessing request after finishing the initialization synchronization of the data block according to the small-granulated exclusive lock function.

3. The remote replication synchronizing/accessing system as claimed in claim 1, wherein when the data block position corresponding to the data-accessing request operation is before that corresponding to the current initialization synchronous operation, the request processing module directly processes the data-accessing request, so as to perform a remote replication for the remote mirroring system.

4. The remote replication synchronizing/accessing system as claimed in claim 1, further comprising a remote replication module, for performing the remote replication for the remote mirroring system according to the data-accessing request.

5. The remote replication synchronizing/accessing system as claimed in claim 1, wherein when the data block position corresponding to the data-accessing request operation is after that corresponding to the current initialization synchronous operation, the synchronization module sequentially performs the initialization synchronization on the data block corresponding to the data-accessing request operation after the data-accessing request is processed according to the small-granulated exclusive lock function.

6. A remote replication synchronizing/accessing method, applied between a local system and a remote mirroring system of the local system, the method comprising:
performing an initialization synchronous operation of the remote mirroring system sequentially according to a sequence of data blocks in a storage of the local system after the remote mirroring system is created;
establishing a small-granulated exclusive lock function between the initialization synchronous operation and a data-accessing request operation of the local system, so as to prevent the initialization synchronous operation and the data-accessing request operation from being conducted on the same data block in the storage at the same time;
determining whether a data block position corresponding to the current initialization synchronous operation is the same as that corresponding to the data-accessing request operation during the initialization synchronous process of the remote mirroring system; and
when the data block position corresponding to the data-accessing request operation is the same as that corresponding to the current initialization synchronous operation, processing the data-accessing request after finishing the initialization synchronization of the data block according to the small-granulated exclusive lock function.

7. The remote replication synchronizing/accessing method as claimed in claim 6, wherein when the data block position corresponding to the data-accessing request operation is before that corresponding to the current initialization synchronous operation, the data-accessing request is directly performed and a remote replication for the remote mirroring system is performed according to the data-accessing request.

8. The remote replication synchronizing/accessing method as claimed in claim 6, wherein when the data block position corresponding to the data-accessing request operation is after that corresponding to the current initialization synchronous operation, the initialization synchronization is sequentially performed on the data block corresponding to the data-accessing request operation after the data-accessing request is processed according to the small-granulated exclusive lock function.

9. The remote replication synchronizing/accessing method as claimed in claim 8, wherein the step of performing the initialization synchronization after the data-accessing request is processed further comprises:
adding the data-accessing request to a list;
after the initialization synchronous operation is finished, sequentially modifying the data block position corresponding to the initialization synchronous operation;
reading the data-accessing request in the list;
determining whether the modified position of the data block is the same as that corresponding to the data-accessing request; and
when the positions are the same, performing an initialization synchronization of the data block after the data-accessing request is processed.

10. The remote replication synchronizing/accessing method as claimed in claim 9, further comprising a step of deleting the data-accessing request from the list after the data-accessing request is processed.

11. The remote replication synchronizing/accessing method as claimed in claim 9, further comprising a step of performing a remote replication for the remote mirroring system according to the data-accessing request after the initialization synchronization of the data block is finished.
